(19) United States
(12) Patent Application Publication
(10) Pub. No.: US 2026/0255151 A1
(43) Pub. Date: Aug. 27, 2026

(54) METHOD AND APPARATUS FOR NOTIFICATION OF UPF RELOCATION TO CONSUMER NF

(71) Applicant: Samsung Electronics Co., Ltd., Suwon-si, Gyeonggi-do (KR)

(72) Inventors: Naman GUPTA, Suwon-si (KR); Kisuk KWEON, Suwon-si (KR)

(21) Appl. No.: 18/854,377

(22) PCT Filed: May 4, 2023
(86) PCT No.: PCT/KR2023/006124

§ 371 Date: Oct. 4, 2024

(30) Foreign Application Priority Data
May 6, 2022 (KR) 10-2022-0056158

(51) Int. Cl. H04W 8/20

(52) U.S. Cl. CPC H04W 8/20

(57) ABSTRACT

The disclosure relates to a 5G or 6G communication system for supporting a higher data transmission rate. A method performed by a consumer network function (NF) in a wireless communication system is provided. The method includes transmitting, to a first user plane function (UPF), a first subscription message for event exposure service, wherein the subscription message includes an indication associated with a relocation of UPF; receiving, from the first UPF, an event notification message indicating a relocation of UPF from the first UPF to a second UPF; and determining, whether to modify a subscription for the first UPF.

### TECHNICAL FIELD

This disclosure generally relates to the field of wireless communication, and in particular, to a method and an apparatus for notification of UPF relocation to consumer NF.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In the present 5G network system, there are numerous events which hold significant interest for monitoring purposes. These events can be monitored by entities within the network and/or by entities external to the network.

Network exposure is a useful tool for making network capabilities and data easily accessible to various entities. In the 5G network, network exposure mainly includes the retrieval of data from an external party by the Network Data Analytics Function (NWDAF), exposure of analytics to an external party, and the exposure of the number of registered User Equipments (UEs) and/or established Packet Data Units (PDU) sessions for a network slice.

External exposure of network capabilities includes the following:
Monitoring capability—monitoring specific events for a UE in the 5GS
Provisioning capability—allowing external parties to provision information for a UE
Policy/charging capability—handling policies of a UE based on the request of an external party
Internal Event Exposure—In addition to notifying external functions or third parties about special events in the 5GS, core network entities can also subscribe to events from other network entities. For example, the exposure of mobility events from Access and Mobility Management Function (AMF) and the exposure of communication/ session-related trends from Session Management Function (SMF).

The User Plane Function (UPF) of the 5G System is mainly focused on packet processing, forwarding and routing, providing vital data related to QoS flows or PDU Sessions to other network functions or external applications, which can be used for network analytics.

As of Release 17, the only contact point of the UPF with the 5G control plane is SMF. Any entity that seeks UPF related data needed to negotiate with SMF. The data gathered at UPF is sent to SMF via the N4 Session Report, and the SMF then sent it to the consumer network entity.

However, this increases the signaling burden on the SMF and leads to increased latency in critical UPF information reaching the consumer network entity.

To address this issue, the UPF Enhancement for Exposure and SBA (Service-based Architecture) proposes integrating UPF into the Service-based Architecture of 5G Core.

The study enables the UPF with Exposure services, namely Nupf_EventExposure, and proposes three service operations: Nupf_EventExposure_Subscribe, Nupf_EventExposure_Unsubscribe, and Nupf_EventExposure_Notify.

For the purposes of this invention, we assume that a consumer NF (Network Function) can subscribe to UPF event exposure services for a particular UE's PDU Session, a particular Application Flow (identified by Application ID), or a particular QoS Flow (identified by QoS Id).

### DISCLOSURE OF INVENTION

### Technical Problem

The purpose of this application is to be able to solve at least one of the drawbacks of the prior art.

There is a need to improve the procedure of UPF subscription for event exposure, in case of UPF relocation.

There is a need to lighten the burdens of the SMF in case of UPF relocation.

### Solution to Problem

According to at least one embodiment of the disclosure, a method performed by a consumer network function (NF) in a wireless communication system is provided.

The method of the consumer NF includes transmitting, to a first user plane function (UPF), a first subscription message for event exposure service, wherein the subscription message includes an indication associated with a relocation of UPF; receiving, from the first UPF, an event notification message indicating a relocation of UPF from the first UPF to a second UPF; and determining, whether to modify a subscription for the first UPF.

In an embodiment, the indication associated with a relocation of UPF indicates to transmit information on the second UPF to the consumer NF in case of the relocation of UPF, and he event notification message further includes information on the second UPF.

In an embodiment, the method further includes transmitting, to the second UPF, a second subscription message for event exposure service; and receiving, from the second UPF, response message corresponding to the second subscription message.

In an embodiment, the indication associated with a relocation of UPF indicates to subscribe to the second UPF on behalf of the consumer NF, and the subscription to the second UPF on behalf of the consumer NF is performed by the first UPF.

In an embodiment, the method further includes transmitting, to the first UPF, a message for unsubscribing the first UPF based on determination to modify the subscription for the first UPF.

According to at least one embodiment of the disclosure, a method of a first user plane function (UPF) in a wireless communication system is provided.

The method of a first UPF includes receiving, from a consumer network function (NF), a first subscription message for event exposure service, wherein the subscription message includes an indication associated with a relocation of UPF; transmitting, to a session management function (SMF), a third subscription message for UPF relocation; receiving, from the SMF, information on a second UPF in case that the relocation of UPF is performed by the SMF; and transmitting, to the consumer NF, an event notification message indicating a relocation of UPF from the first UPF to the second UPF.

In an embodiment, the method further includes including the information on the second UPF in the event notification message, wherein the indication associated with a relocation of UPF indicates to transmit information on the second UPF to the consumer NF.

In an embodiment, the method further includes transmitting, to the second UPF, a fourth subscription message on behalf of the consumer NF for event exposure.

### Advantageous Effects of Invention

Embodiments of the present disclosure provides methods and apparatus for enabling the consumer NF to subscribe to target UPF event exposure service without the need to query through SBF or NRF for the target UPFs.

According to embodiments of the present disclosure, latency for a critical UPF information reaching to a consumer entity can be improved.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a structure of a 5G network according to an embodiment of the disclosure.

FIG. 2 illustrates a procedure for traditional scenario for a subscription to UPF event exposure.

FIG. 3 illustrates a scenario for UPF event exposure service.

FIG. 4 illustrates a scenario for relocation of the UPF.

FIG. 5 illustrates a procedure for present invention's scenario for a subscription to UPF event exposure.

FIG. 6 illustrates components of a consumer NF according to an embodiment of the disclosure.

FIG. 7 illustrates components of a network entity according to an embodiment of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Hereinafter, exemplary embodiments of the disclosure will be described in detail with reference to the accompanying drawings. Here, it is noted that identical reference numerals denote the same structural elements in the accompanying drawings. Further, a detailed description of a known function and configuration which may make the subject matter of the disclosure unclear will be omitted.

In describing the exemplary embodiments of the disclosure, descriptions related to technical contents which are well-known in the art to which the disclosure pertains, and are not directly associated with the disclosure, will be omitted. Such an omission of unnecessary descriptions is intended to prevent obscuring of the main idea of the disclosure and more clearly transfer the main idea.

For the same reason, in the accompanying drawings, some elements may be ex-aggerated, omitted, or schematically illustrated. Further, the size of each element does not entirely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

### Abbreviations

SBI: Service Based Interface, the interface between 5G core functions
PCFP: Packet Forwarding Control Protocol
UP: User Plane

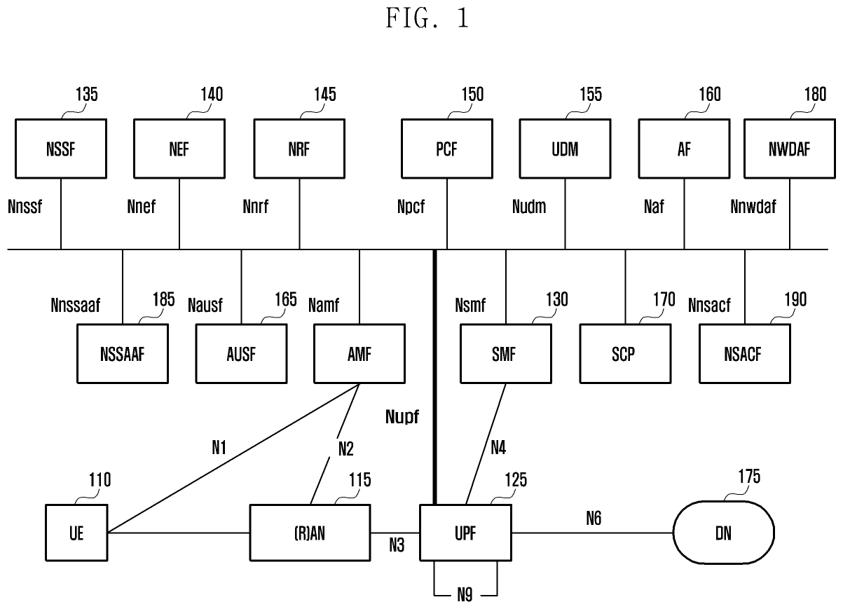

FIG. 1 illustrates a structure of a 5G network according to an embodiment of the disclosure.

With reference to FIG. 1, descriptions of network entities or network nodes constituting a 5G network are as follows.

An (radio) access network ((R)AN) 115 is a subject that performs radio resource allocation of a terminal 110 and may be an at least one of an eNode B, a node B, a base station (BS), a next generation radio access network (NG-RAN), a 5G-AN, a radio access unit, a base station controller, or a node on a network. The terminal 110 may include a user equipment (UE), a next generation UE (NG UE), a mobile station (MS), a cellular phone, a smart phone, a computer, or a multimedia system capable of performing a communication function. Hereinafter, although the embodiment of the disclosure is described by taking the 5G system as an example, the embodiment of the disclosure may be applied to other communication systems having a similar technical background. Further, the embodiments of the disclosure may be applied to other communication systems through some modifications within a range that does not significantly depart from the scope of the disclosure as determined by a person having skilled technical knowledge.

The wireless communication system defines a next generation (gen) core (NG core) or a 5G core network (5GC), which is a new core network as it evolves from a 4G system to a 5G system. The new core network virtualized all the existing network entities (NEs) and made it into a network function (NF). According to an embodiment of the disclosure, a network function may mean a network entity, a network component, and a network resource.

According to an embodiment of the disclosure, a 5GC may include NFs illustrated in FIG. 1. The 5GC is not limited to an example of FIG. 1 and may include a larger number of NFs or a smaller number of NFs than that illustrated in FIG. 1.

According to an embodiment of the disclosure, an access and mobility management function (AMF) 120 may be a network function for managing the mobility of the terminal 110.

According to an embodiment of the disclosure, a session management function (SMF) 130 may be a network function for managing a packet data network (PDN) connection provided to the terminal 110. The PDN connection may be referred to as a protocol data unit (PDU) session.

According to an embodiment of the disclosure, a policy control function (PCF) 150 may be a network function that applies a service policy of a mobile communication operator to a terminal, a charging policy, and a policy for a PDU session.

According to an embodiment of the disclosure, unified data management (UDM) 155 may be a network function for storing information on a subscriber.

According to an embodiment of the disclosure, a network exposure function (NEF) 140 may be a function of providing information on the terminal to a server outside the 5G network. Further, the NEF 140 may provide a function of providing information necessary for providing a service to the 5G network and storing the information in a user data repository (UDR) (not illustrated).

According to an embodiment of the disclosure, a user plane function (UPF) 125 may be a function that serves as a gateway for transferring user data (PDU) to a data network (DN) 175. In particular, in the disclosure, Nupf, which is an SBI interface, is defined to the UPF 125, thereby providing an event exposure service to other NFs.

According to an embodiment of the disclosure, a network repository function (NRF) 145 may perform a function of discovering the NF.

According to an embodiment of the disclosure, an authentication server function (AUSF) 165 may perform terminal authentication in a 3GPP access network and a non-3GPP access network.

According to an embodiment of the disclosure, a network slice selection function (NSSF) 135 may perform a function of selecting a network slice instance provided to the terminal 140.

According to an embodiment of the disclosure, a service communication proxy (SCP) 170 may provide an indirect communication method that substitutes for service search, call, response, and the like in interworking between NFs.

According to an embodiment of the disclosure, the DN 175 may be a data network in which the terminal 110 transmits and receives data in order to use a service of a network provider or a 3rd party service.

According to an embodiment of the disclosure, Network Slice Specific Authentication and Authorization Function (NSSAAF) 185 may support network slice specific authentication and authorization using Authentication Authorization and Accounting (AAA) server. In addition, the NSSAAF 185 may support access to the SNPN using the credentials of the credentials holder.

According to an embodiment of the disclosure, Network Slice Access Control Function (NSACF) 190 may support monitoring and control of the number of registered UEs per network slice, support monitoring and control of the number of PDU sessions configured per network slice, and/or support event-based network slice status notification and reporting for consumer NFs.

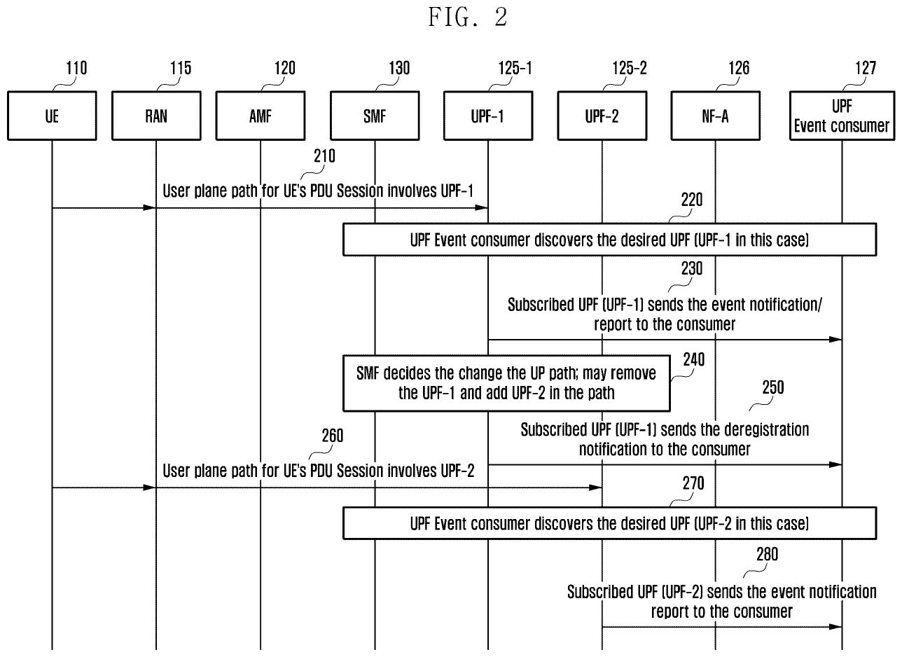

FIG. 2 illustrates a procedure for traditional scenario for a subscription to UPF event exposure.

In the scenario of FIG. 2, event consumer may need to discover a new UPF in case of UPF path change (UPF relocation).

Network function-A (NF-A) 126 may be composed of UDM, BSF or NRF. NF-A is used to find the desired UPF by the UPF event consumer 127.

In FIG. 2, UPF-1 125-1 initially serves a particular UE's PDU session.

In step 210, the UE 110 may establish user plane path for UE's PDU session with UPF-1 125-1.

In step 220, UPF event consumer performs the discovery of the new UPF (UPF-2) 125-2 for the UPF-1 125-1 that is serving a UE's PDU Session or a particular QoS flow for a particular application again and subscribes for UPF event exposure services.

In step 230, UPF-1 125-1 reports any events or measurement data to the UPF event consumer 127, based on the Event Consumer's subscribed events.

In step 240, SMF 130 decides to change the User plane path for the particular PDU Session According to some triggers or policies. This may involve changing the UPF and/or inserting an I-UPF in the UP path for the UE's PDU Session. In the FIG. 2, SMF 130 decides to remove UPF-1 125-1 in the User Plane path for the UE's PDU Session and add UPF-2 125-2 instead.

In step 250, UPF-1 125-1 sends a deregistration notification to the UPF event consumer 127 to notify it that the UPF-1 125-1 no longer serves the desired PDU session or application flow.

In step 260, New UPF (UPF-2) 125-2 for the UE's PDU Session registers itself for the UE's PDU Session at the NF-A 126.

In step 270, UPF event consumer 127 performs the discovery of the new UPF for the UPF that is serving a UE's PDU Session or a particular QoS flow for a particular application again and subscribes for UPF event exposure services.

In step 280, UPF-2 125-2 reports any events or measurement data to the UPF event consumer 127 based on the Event Consumer's subscribed events.

As seen from the FIG. 2, UE 100 has to perform step 270 to discover the UPF serving the UE's PDU session again and subscribe for event reporting to the new UPF (UPF-2). In addition, the target UPF 125-2 would have to first register itself for the new PDU Session in the NRF, then consumer NF 127 would have either queried to 5G NFs for getting the target UPF service endpoint, and then would have finally subscribed for Event Exposure service.

This can lead to multiple signaling between the 5G network functions and thus a delay for the UPF event consumer 127 to get the Event notification or reporting data from the new UPF.

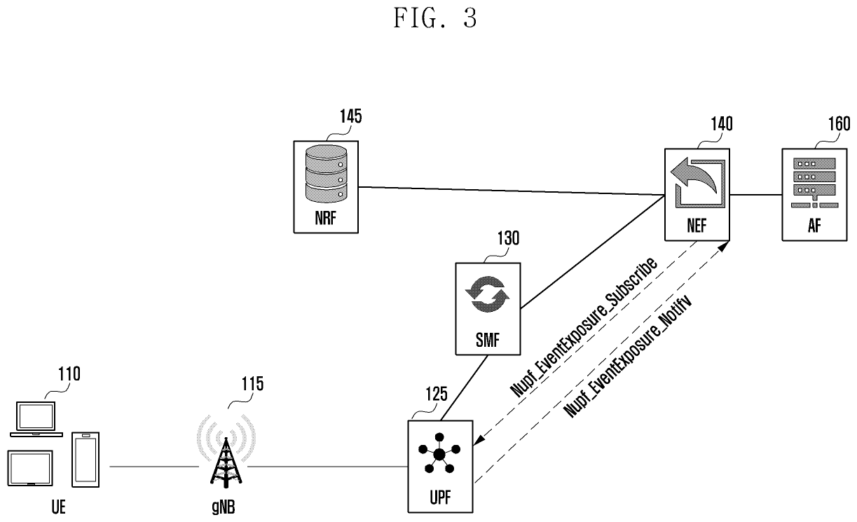

FIG. 3 illustrates a scenario for UPF event exposure service.

In the scenario, UPF event consumer can be NEF, AF, NWDAF or SMF.

In FIG. 3, a UE 110 is connected to the 5GS and is being serviced a PDU Session. The NEF 140 on behalf of AF 160 has subscribed to UPF Event Exposure service for UE's PDU Session.

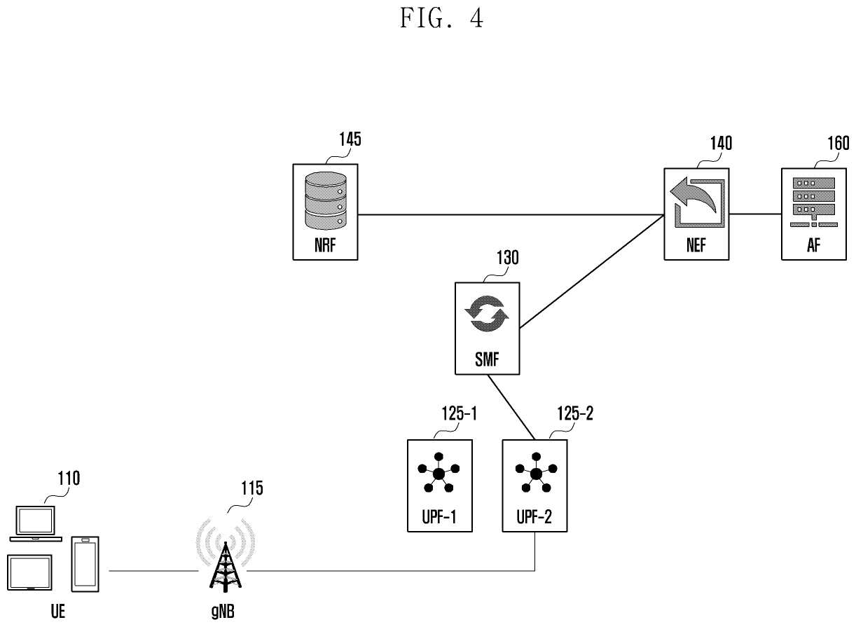

Due to UE mobility or for other reasons such as load balancing, SMF 130 may decide to change the UPF serving this particular PDU Session. This scenario is depicted in FIG. 4.

FIG. 4 illustrates a scenario for relocation of the UPF.

In FIG. 4, in event of changes in UP path (that is a new UPF 125-2 may be added and/or old UPF 125-1 may be removed), the UPF event consumer needs to subscribe for UPF event/reporting information from the new UPF 125-2 that is added to UP path of the PDU Session for which UPF Event consumer wants the event notifications.

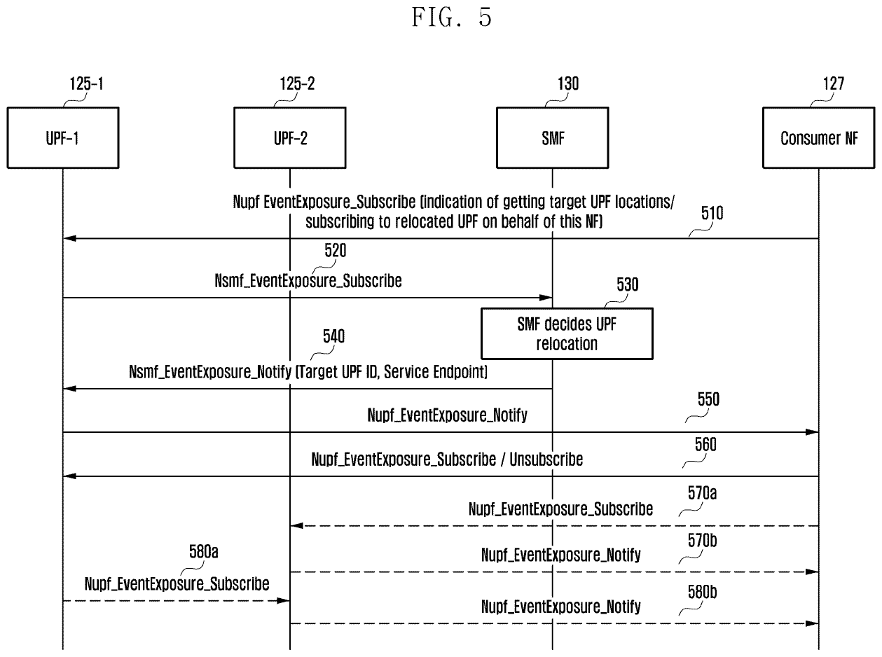

FIG. 5 illustrates a procedure for present invention's scenario for a subscription to UPF event exposure.

FIG. 5 describe the improvement proposed by this disclosure a mechanism for how the NF (which is consumer of UPF Exposure Service for a particular PDU Session) can subscriber to new UPF when there is a change in UP path for the desired UE's PDU Session, without performing discovery of the new UPF.

In an embodiment, the UPF can get the info of the target UPF service endpoints from the serving SMF.

FIG. 5 does not illustrate the signalings of N4 session procedures. It can be assumed that the signalings of N4 session procedures would be carried out as usual in accordance with the 3GPP N4 session procedures. It can be assumed that N4 session signaling are upgraded to negotiate the parameters between SMF and UPF required for UPF exposure service.

In FIG. 5, there are two alternatives ways by which the consumer NF can subscribe to the new UPF.

In embodiment 1, the source UPF (to which the consumer NF was already subscribed to) can send the Target UPF ID and service endpoint to the consumer NF. Consumer NF can then Subscribe to it via Nupf_EventExposure_Subscribe operation. When UPF event consumer (for example AF/NEF/NWDAF) subscribes to UPF for event notification, UPF event consumer can include an indication in the subscription request “to transmit information to consumer NF for target UPF in case of UP path change”. Embodiment 1 is described via step 510-560 and 570a, 570b of FIG. 5. In this case, the source UPF (to which the consumer NF was already subscribed to) can send the target UPF ID and service endpoint to the consumer NF. Consumer NF can subscribe to target UPF using the target UPF ID via Nupf_EventExposure_Subscribe operation.

In embodiment 2, During the subscription to the source UPF, the consumer NF can indicate to subscribe to the Target UPF on behalf of itself (consumer NF) whenever UPF relocation happens. When UPF event consumer (for example AF/NEF/NWDAF) subscribes to UPF for event notification, it can include an indication in the subscription request “to subscribe to target UPF on behalf of the UPF event consumer”. Embodiment 2 is described via step 510-560 and 580a, 580b of FIG. 5. In this case, during the subscription to the source UPF, the consumer NF can indicated to the source UPF to subscribe to the target UPF on behalf of the consumer NF itself whenever UPF relocation is performed.

For convenience of description, various embodiments of the present invention are separately described, but some steps of each embodiment may be merged to constitute the invention.

In the description, UPF-1 125-1 may correspond to the source, and UPF-2 125-2 may correspond to the target UPF. Consumer NF 127 can consist of NEF, NWDAF or other network function entity.

### Embodiment 1

In step 510, the consumer NF 127 subscribes to UPF-1 125-1 for event exposure services for a particular PDU session. Subscription request can be performed via a Nupf_EventExposure_Subscribe message. The request can include indication in the subscription request “to transmit information for target UPF to the consumer NF in case of UP path change”.

In step 520, UPF-1 125-1 transmit a subscription request message to SMF 130 via Nsmf_EventExposure_Subscribe message. This service operation allows the UPF-1 125-1 to subscribe for event notifications on a specified PDU Session. In this step 520, the UPF-1 125-1 subscribes to the SMF 130 regarding UPF change for the PDU Session.

In step 530, SMF may perform decisions for UPF relocation. For example, as the UE 110 moves from one location to another, SMF 130 may decide that the current UPF-1 125-1 is no longer capable to serve the PDU session efficiently, so SMF 130 may decide to insert a UPF or change the current serving UPF for the PDU Session.

In step 540, SMF 130 notifies the UPF-1 125-1 regarding UPF ID of UPF-2 125-2 and the Nupf_Exposure service endpoint. This notification can be transmitted as Nsmf_EventExposure_Notify message.

In step 550, UPF-1 125-1 can transmit Nupf_EventExposure_Notify message to the consumer NF 127. In case that the consumer NF 127 in step 510 had indicated to get target UPF (UPF-2) information, UPF-1 125-1 notifieds the consumer NF 127 with the information received from the SMF 130. The information can includes target UPF ID (UPF-2 ID), service endpoint, etc.

In step 560, consumer NF 127 can transmit Nupf_EventExposure_Notify message to UPF-1 125-1. On the basis of the received notification in step 550, the consumer NF 127 may either decide to modify the event exposure. The modification can include a subscription or an unsubscription.

In step 570a, the consumer NF 127 may subscribe to the UPF-2 125-2 for event exposure service for the UE's PDU session using the information received from UPF-1 125-1 in step 550.

In step 570b, UPF-2 125-2 may transmit reply message for the subscription request to the consumer NF 127.

In the embodiment 1, Steps 580a and 580b may not be performed.

### Embodiment 2

In step 510, the consumer NF 127 subscribes to UPF-1 125-1 for event exposure services for a particular PDU session. Subscription request can be performed via a Nupf_EventExposure_Subscribe message. The request can include an indication in the subscription request “to subscribe to target UPF on behalf of the UPF event consumer”.

In step 520, UPF-1 125-1 transmit a subscription request message to SMF 130 via Nsmf_EventExposure_Subscribe message. This service operation allows the UPF-1 125-1 to subscribe for event notifications on a specified PDU Session. In this step 520, the UPF-1 125-1 subscribes to the SMF 130 regarding UPF change for the PDU Session.

In step 530, SMF may perform decisions for UPF relocation. For example, as the UE 110 moves from one location to another, SMF 130 may decide that the current UPF-1 125-1 is no longer capable to serve the PDU session efficiently, so SMF 130 may decide to insert a UPF or change the current serving UPF for the PDU Session.

In step 540, SMF 130 notifies the UPF-1 125-1 regarding UPF ID of UPF-2 125-2 and the Nupf_Exposure service endpoint. This notification can be transmitted as Nsmf_EventExposure_Notify message.

In step 550, UPF-1 125-1 can transmit Nupf_EventExposure_Notify message to the consumer NF 127. UPF-1 125-1 may notify the consumer NF 127 that UPF-1 125-1 no longer serves the consumer NF's requested PDU session.

In step 560, consumer NF 127 can transmit Nupf_EventExposure_Notify message to UPF-1 125-1. On the basis of the received notification in step 550, the consumer NF 127 may either decide to modify the event exposure. The modification can include a subscription or an unsubscription.

In the embodiment 1, Steps 570a and 570b may not be performed.

In step 580a, In case that the consumer NF 127 indicated to subscribe to the relocated UPF (UPF-2) on behalf of the consumer NF 127 in step 510, UPF-1 125-1 subscribes to UPF-2 125-2 for event exposure service with notification target of consumer NF 127. This subscription can be performed via Nupf_EventExposure_Subscribe message. UPF-1 125-1 can use SBI API (for example Nupf_EventExposure Service) to subscribe to the UPF-2 125-2.

In step 580b, UPF-2 125-2 may notify about the PDU session event to the consumer NF 127 via Nupf_Event_Exposure_Notify message.

Following the above procedure flow of embodiment 1 or embodiment 2, the consumer NF 127 is able to subscribe to target UPF event exposure service for the interested PDU sessions, without the need to query through SBF and(or) NRF for the target UPFs.

In an embodiment, UPF and SMF can communicate with each other via SBI in addition to the N4 interface (PFCP). That is introduction of SBI service APIs/signaling between the SMF and the UPF such as Nsmf_Event Exposure/Nsmf_EventExpoure Notify/Nupf_EventExposure/Nupf_EventExposure.

In an embodiment, various subscription request messages in FIG. 5 (in step 510, 520, 560, 570a, 580a) may include parameters such as N4 session ID, PDU session ID, UE ID, QFI (QoS Flow ID), type of user plane change (e.g. addition of an I-UPF, changing of serving UPF for the PDU session), etc.

In an embodiment, various notification messages in FIG. 5 (in step 540, 550, 570b, 580b) may include target UPF ID, IP address of the target UPF, list of supported event ID(s) by the target UPF, Nupf_Exposure service endpoint.

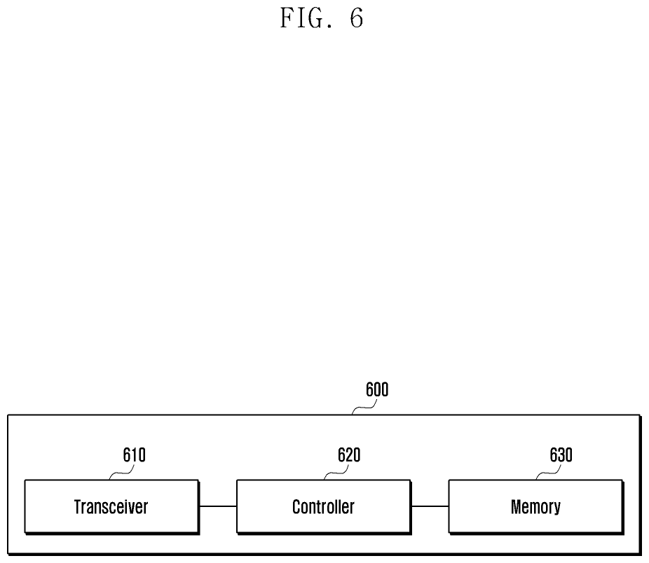

FIG. 6 illustrates components of a consumer NF according to an embodiment of the disclosure.

The consumer NF 600 according to various embodiments may include a transceiver 610, a controller 620, and a memory 630.

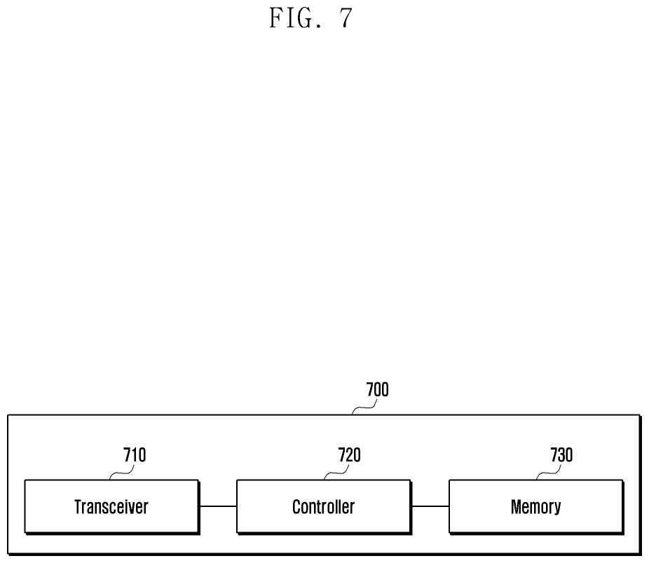

The transceiver 610 according to various embodiments may transmit and receive a signal, information, data, etc. according to various embodiments of the disclosure to and from the network entity 700 of FIG. 7. For example, the transceiver 610 may transmit information related to subscription message to a UPF.

For example, the transceiver 610 according to various embodiments may receive an event notification message from the network entity 700.

The controller 620 is a component for overall controlling the consumer NF 600. The controller 620 may include at least one processor. Hereinafter, a controller may be interchangeably used with a processor.

The processor 620 may control the overall operation of the consumer NF 600 according to various embodiments of the disclosure as described above.

For example, the at least one processor 620 according to various embodiments may control the transceiver 610 to transmit and receive a signal, information, data, etc.

For example, the at least one processor 620 may determine whether to modify a subscription for the source UPF.

The memory 630 of the consumer NF 600 may store data such as a basic program, an application program, and configuration information for the operation of the consumer NF 600. In addition, the memory may include at least one storage medium among a flash memory type, a hard disk type, a multimedia card micro type, a card type memory (e.g., an SD or XD memory, etc.), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM). In addition, the processor 1120 may perform various operations by using various programs, contents, data, etc. stored in the memory.

FIG. 7 illustrates components of a network entity according to an embodiment of the disclosure. According to various embodiments of the present invention, the network entity may be composed of AMF, SMF, UPF, etc.

The network entity 700 according to various embodiments may include a transceiver 710, a controller 720, and a memory 730.

The transceiver 710 according to various embodiments may transmit and receive a signal, information, data, etc. according to various embodiments of the disclosure to and from the terminal 600 of FIG. 6. For example, the transceiver 710 may transmit event-related information to the terminal. For example, the transceiver 710 according to various embodiments may receive an event subscription request message from the terminal.

For example, the event subscription request message according to various embodiments may include the event-related information.

The controller 720 is a component for overall controlling the network entity 700. The controller 720 may include at least one processor. Hereinafter, a controller may be interchangeably used with a processor.

The processor 720 may control the overall operation of the network entity 700 according to various embodiments of the disclosure as described above.

For example, the at least one processor 720 according to various embodiments may control the transceiver 710 to transmit or receive an event subscription request message from the terminal 600 or another network entity.

The memory 730 of the network entity 700 may store data such as a basic program, an application program, and configuration information for the operation of the subscription relay server 1200. In addition, the memory may include at least one storage medium among a flash memory type, a hard disk type, a multimedia card micro type, a card type memory (e.g., an SD or XD memory, etc.), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM). In addition, the processor 1220 may perform various operations by using various programs, contents, data, etc. stored in the memory.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, all the embodiment of the disclosure may be partially combined to operate a base station and a terminal.

Although the present disclosure has been described with various embodiments, various changes and modifications may be suggested to one skilled in the art. It is intended that the present disclosure encompass such changes and modifications as fall within the scope of the appended claims.

1. A method performed by a consumer network function (NF) in a wireless communication system, the method comprising:
transmitting, to a first user plane function (UPF), a first subscription message for event exposure service, wherein the subscription message includes an indication associated with a relocation of UPF;
receiving, from the first UPF, an event notification message indicating a relocation of UPF from the first UPF to a second UPF; and
determining, whether to modify a subscription for the first UPF.

2. The method of claim 1,
wherein the indication associated with a relocation of UPF indicates to transmit information on the second UPF to the consumer NF in case of the relocation of UPF, and
wherein the event notification message further includes information on the second UPF.

3. The method of claim 2, further comprising:
transmitting, to the second UPF, a second subscription message for event exposure service; and
receiving, from the second UPF, response message corresponding to the second subscription message.

4. The method of claim 1,
wherein the indication associated with a relocation of UPF indicates to subscribe to the second UPF on behalf of the consumer NF, and
wherein the subscription to the second UPF on behalf of the consumer NF is performed by the first UPF.

5. The method of claim 1, further comprising:
transmitting, to the first UPF, a message for unsubscribing the first UPF based on determination to modify the subscription for the first UPF.

6. A method of a first user plane function (UPF) in a wireless communication system, the method comprising:
receiving, from a consumer network function (NF), a first subscription message for event exposure service, wherein the subscription message includes an indication associated with a relocation of UPF;
transmitting, to a session management function (SMF), a third subscription message for UPF relocation;
receiving, from the SMF, information on a second UPF in case that the relocation of UPF is performed by the SMF; and
transmitting, to the consumer NF, an event notification message indicating a relocation of UPF from the first UPF to the second UPF.

7. The method of claim 6, further comprising:
including the information on the second UPF in the event notification message,
wherein the indication associated with a relocation of UPF indicates to transmit information on the second UPF to the consumer NF.

8. The method of claim 6, further comprising,
transmitting, to the second UPF, a fourth subscription message on behalf of the consumer NF for event exposure.

9. A consumer network function (NF) in a wireless communication system, the consumer network function comprising:
a transceiver; and
a controller configured to:
transmit, to a first user plane function (UPF) via the transceiver, a first subscription message for event exposure service, wherein the subscription message includes an indication associated with a relocation of UPF,
receive, from the first UPF via the transceiver, an event notification message indicating a relocation of UPF from the first UPF to a second UPF, and
determine whether to modify a subscription for the first UPF.

10. The consumer NF of claim 9,
wherein the indication associated with a relocation of UPF indicates to transmit information on the second UPF to the consumer NF in case of the relocation of UPF, and
wherein the event notification message further includes information on the second UPF.

11. The consumer NF of claim 10,
wherein the controller is further configured to:
transmit, to the second UPF via the transceiver, a second subscription message for event exposure service, and
receive, from the second UPF via the transceiver, response message corresponding to the second subscription message.

12. The consumer NF of claim 9,
wherein the indication associated with a relocation of UPF indicates to subscribe to the second UPF on behalf of the consumer NF, and
wherein the subscription to the second UPF on behalf of the consumer NF is performed by the first UPF.

13. A first user plane function (UPF) in a wireless communication system, the first UPF comprising:
a transceiver; and
a controller configured to:
receive, from a consumer network function (NF), a first subscription message for event exposure service, wherein the subscription message includes an indication associated with a relocation of UPF,
transmit, to a session management function (SMF), a third subscription message for UPF relocation,
receive, from the SMF, information on a second UPF in case that the relocation of UPF is performed by the SMF, and
transmit, to the consumer NF, an event notification message indicating a relocation of UPF from the first UPF to the second UPF.

14. The first UPF of claim 13,
wherein the controller is further configured to:
include the information on the second UPF in the event notification message,
wherein the indication associated with a relocation of UPF indicates to transmit information on the second UPF to the consumer NF.

15. The first UPF of claim 13,
wherein the controller is further configured to:
transmit, to the second UPF, a fourth subscription message on behalf of the consumer NF for event exposure.
